(19) United States
(12) Patent Application Publication
(10) Pub. No.: US 2020/0226513 A1
(43) Pub. Date: Jul. 16, 2020

(54) STRATEGY AUTOMATION PLATFORM

(71) Applicant: ayeQ, LLC, Belmont, NC (US)

(72) Inventors: Dana Lee Marxer, Belmont, NC (US); Kia Alexandria Christopher, Canton, NC (US); Bret Michael McDermitt, Charlotte, NC (US)

(21) Appl. No.: 16/743,108

(22) Filed: Jan. 15, 2020

Related U.S. Application Data
(60) Provisional application No. 62/793,133, filed on Jan. 16, 2019.

(51) Int. Cl. G06Q 10/06; G06Q 30/02

(52) U.S. Cl. CPC G06Q 10/0637; G06Q 10/06312; G06Q 30/0201; G06Q 10/06393; G06Q 10/06313

(57) ABSTRACT

A marketing strategy automation system is disclosed. The system including a processor; a non-transitory computer readable storage medium coupled to the processor having stored thereon a plurality of instructions that, when executed by the processor, causes the processor to carry out a method, the instructions including: a strategy module; a conversion module; an execution module; and an optimization module.

### BACKGROUND OF THE INVENTION

This invention relates generally to an automated marketing strategy platform.

As illustrated in FIG. 1, today, development of a company's go-to-market strategy is done manually, created by a company's executive team and often facilitated by outside consultants. The strategy exists in a standalone document, such as Microsoft PowerPoint, Word, Excel—or some combination of the three. Budgeting is done in a separate financial system and reported out to the various functions through the financial tool, or, most often, through a spreadsheet, such as Excel.

Often, especially in emerging companies or those with less strategic expertise on their executive teams, the go-to-market strategy consists of revenue targets associated with the products or solutions offered. It is the “What do we want to book next year?” rather than “How are we going to grow x % next year?”, causing companies to engage expensive consulting resources to help them develop go-to-market strategies.

The rest of the organization then creates their own plans to enable the organization to achieve the strategic goals. Almost always, the strategic plan will include company growth targets, as well as strategic initiatives that will enable growth. Marketing and Sales functions are typically the most closely aligned with the strategic plan, given they are the functions that directly generate sales growth.

Sales typically creates a plan for their sales team to hit the bookings targets identified in the corporate strategy. This will include sales quotas by sales representatives. Again, these goals are documented in a separate sales plan document.

Meanwhile, Marketing is developing their marketing plan to generate leads for the Inside Sales function to qualify and send to Sales. The most common questions during this process are, “How many leads do I need to generate?”; “What should my targets be?”; and “How many Inside Sales representatives do I need, and how should I goal them?” Marketing will typically guess at an achievable goal, Sales will ask for more, and they will land at some number—not necessarily tied to what is actually required to hit the corporate bookings goal.

Marketing will develop branding and messaging, usually disconnected from the Sales planning to create promotional programs and campaigns using their experience to guide their decision-making on tactics. These plans and messages are documented in separate files, typically PowerPoint or Word. They will allocate their assigned budget out across these programs, and hope for the best.

Systems such as Customer Relationship Management (CRM) and Marketing Automation (MA) are used to track tactical execution—sales meetings, opportunities, inside sales conversations, email blasts, marketing responses, and so on. These must be manually configured and instructed and are not tied to sales and marketing plans. Unfortunately, marketing and sales processes are not clearly defined in the systems and data becomes confusing, inconsistent, and inaccurate.

Because marketing and sales leadership (and executives) do not trust the data in the systems, data is exported and manipulated manually. Sales will export their deals into Excel to forecast and commit to quarterly bookings. Marketing will export data from various sources to report on leads and lead sources. But understanding how leads (and marketing activity overall) is actually impacting sales is virtually impossible. This is the age-old question, “I think half of my marketing dollars are effective. I just don't know which half.”

On a quarterly basis, the executive team will have to report out to their board on the results of their strategic plan. This typically involves many weeks of trying to make sense of the various documents across the organization and how activities relate to their original intention. Analysts are often pulled in to make sense of disparate data sources and spend weeks massaging that data to produce reports that reflect the progress of the corporate strategy.

Billions of dollars are spent every year across industries trying to rectify this disconnection across the growth functions of the organization. High-priced strategy consultants, systems architects, reporting and business intelligence tools. There is nothing that has attempted to connect the actual planning of strategy with its execution, streamlining the entire intelligence process across all functions.

Accordingly, there is a need for a marketing platform that automates the process of go-to-market strategy development, converts strategy to organizational goals and execution instructions, automatically directs tactical execution systems, and provides intelligent feedback from tactical execution systems to the strategy development function for optimizing and refining strategy.

### BRIEF SUMMARY OF THE INVENTION

The present invention provides an automated marketing strategy platform that provides the needed bridge between strategy and execution of the strategy.

According to one embodiment of the invention, a marketing strategy automation system includes a processor; a non-transitory computer readable storage medium coupled to the processor having stored thereon a plurality of instructions that, when executed by the processor, causes the processor to carry out a method, the instructions including: a strategy module; a conversion module; an execution module; and an optimization module.

According to another embodiment of the invention, a marketing strategy automation system includes a processor; a non-transitory computer readable storage medium coupled to the processor having stored thereon a plurality of instructions that, when executed by the processor, causes the processor to carry out a method, the instructions including: a strategy module, the strategy module including the processes of defining a market segment, defining unmet needs in the market segment; defining individuals impacted by the unmet needs, and identifying available solutions; a conversion module, the conversion module including the processes of distilling higher level markets and stakeholders into market segments and personas, and generating a messaging framework; an execution module, the execution module including the processes of defining a tactical plan, defining an execution plan, and enabling a creative workspace for individuals to synthesize and review relevant information; and an optimization module, the optimization module including the processes of converting unstructured strategy concepts into a structured representation of strategy.

### BRIEF DESCRIPTION OF THE DRAWINGS

The invention may be best understood by reference to the following description taken in conjunction with the accompanying drawing figures, in which:

FIG. 1 shows a prior art disconnected marketing method;

FIG. 2 illustrates an automated platform according to an embodiment of the invention;

FIG. 3 is an overview of the platform of FIG. 1;

FIG. 4 shows a strategy creation section of the platform of FIG. 1;

FIG. 5 shows a revenue stream definition section of the strategy creation section of FIG. 4;

FIG. 6 shows a strategic foundation section of the strategy creation section of FIG. 4;

FIG. 7 shows a strategic goals section of the strategy creation section of FIG. 4;

FIG. 8 shows a conversion execution section of FIG. 1;

FIG. 9 shows a messaging framework section of the conversion execution section of FIG. 8;

FIG. 10 shows pipeline modeling section of the conversion execution section of FIG. 8;

FIG. 11 shows tactical goals section of the conversion execution section of FIG. 8;

FIG. 12 shows a strategy execution section of the platform of FIG. 1;

FIG. 13 shows tactical planning section of the strategy execution section of FIG. 12;

FIG. 14 shows a project section of the strategy execution section of FIG. 12;

FIG. 15 shows a creative workspace section of the strategy execution section of FIG. 12;

FIG. 16 shows a configuring and syncing section of the strategy execution section of FIG. 12;

FIG. 17 shows a strategy optimization section of the platform of FIG. 1;

FIGS. 18-22 show structured framework methods of the platform of FIG. 1;

FIGS. 23-25 shows scoring performance of the platform of FIG. 1; and

FIGS. 26-27 illustrate a Booking Model of the platform of FIG. 1.

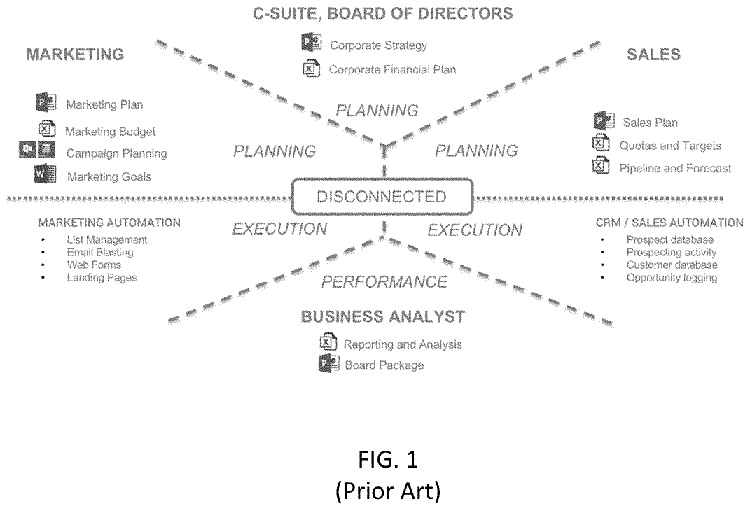

### DETAILED DESCRIPTION OF THE INVENTION

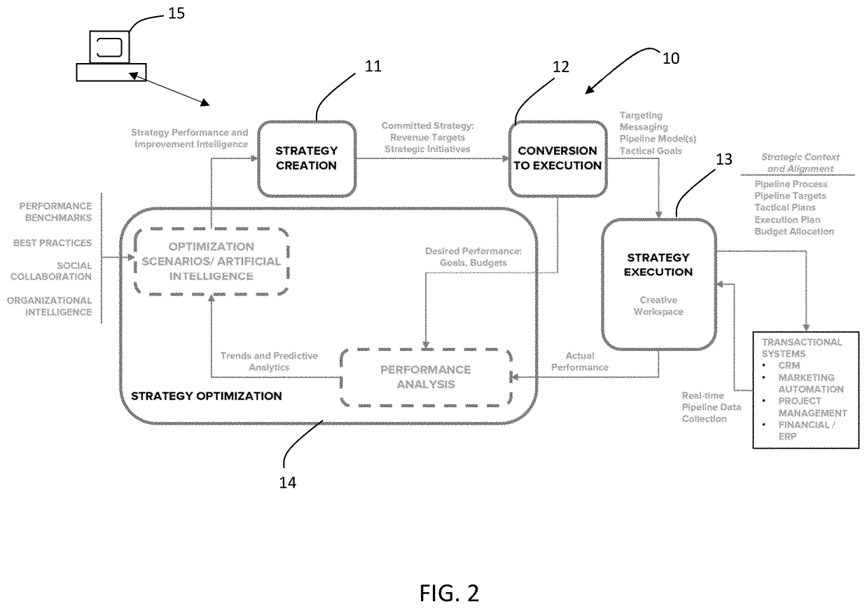

Referring to the drawings wherein identical reference numerals denote the same elements throughout the various views, FIG. 2 depicts an enterprise strategy automation system and/or platform 10. The platform 10 enables organizations to build their strategy along with a bridge between strategy and execution of that strategy and, strengthens the organization's strategy and approach using artificial intelligence, community-engagement, and data modeling feedback loops.

The platform 10 completely changes the process of strategy creation, conversion, execution, and optimization with performance feedback loops from beginning to end. Using unique methods and algorithms, the platform 10 guides executives through the strategy creation process, documenting it automatically in the system; translates the defined strategy into actionable sales and marketing goals; configures the appropriate processes within the transactional execution systems; and uses visual workflows. The workflows guide: marketing through the creation and execution of campaigns that tie directly to the defined strategy; inside sales through the qualification of marketing-generated leads; and sales through the process of opportunity management and ultimately closed deals.

These tactics are automatically populated within the execution systems, and the results of the tactical execution are populated within the platform 10. That performance is evaluated against the defined strategy to uncover trends and predict scenarios that can iteratively improve the initial strategy.

The platform 10 couples the analysis of actual performance with external sources of benchmarking, best practices, crowd-sourced innovation, and organizational intelligence to serve up strategic scenarios for strategy improvement. Feedback and input from the community of organizations creates a social productivity platform that highlights the structure of successful strategy and execution models. Robotics/artificial intelligence gives organizations several additional layers of analysis, resulting in a platform 10 that can make data-fueled decisions towards any stated goal, given specific inputs.

The platform 10 creates end-to-end visibility from strategy to performance, automatically showing strategic performance of the company. Since all strategy and performance is housed in the platform 10, board reports and packages can be automatically generated for board use as needed.

The platform 10 is focused on data-driven performance improvement across all areas of marketing, inside sales, and sales—from strategy creation to tactical execution. The platform 10 is comprised of three key modules: Strategy, block 11, Conversion, block 12, and Execution, block 13—with automation and performance optimization, block 14, built in from beginning to end. Each area is wholly dependent on and connected to its predecessor, and each area provides insights into the operational effectiveness of the other areas to enable iterative improvements. The establishment and connection of the areas and their relationship to integrated performance measurements are the core of the market distinction of the platform 10.

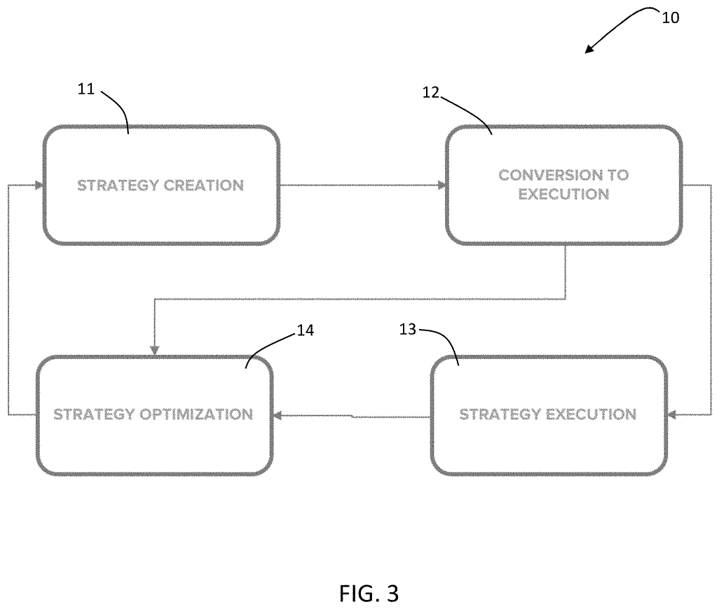

As shown in FIG. 3, in general, the platform 10 is stored on a non-transitory computer readable medium coupled to a processor 15. The platform 10 including instruction and/or code executable by the processor 15 to implement each module and/or step of the platform 10. Non-transitory computer readable medium includes all computer readable media except for a transitory, propagating signal.

The platform 10 establishes and automates the creation of a growth strategy, block 11; converts the strategy to execution through modeling goals, creating frameworks, and allocating budget, block 12; integrates with existing tactical systems to populate strategic parameters, targets, budgets, campaigns, and projects, block 13; and tracks performance of the strategy against the integrated tactical systems to create a feedback loop back into growth strategy—closing the loop in the strategy cycle, block 14.

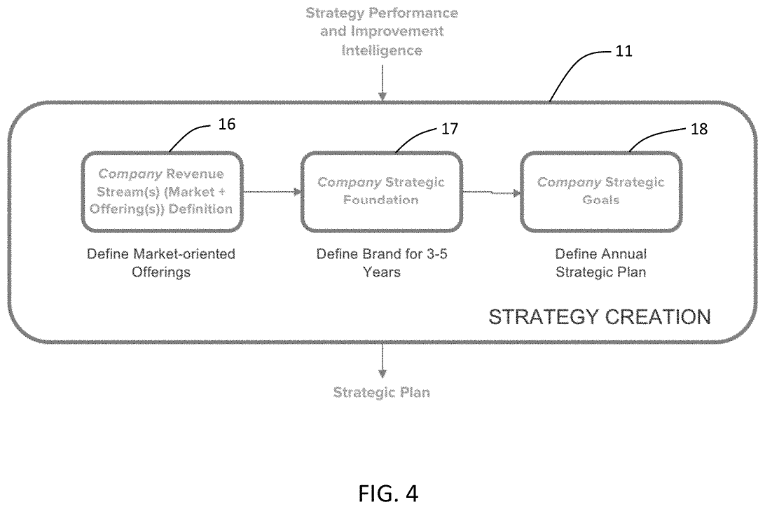

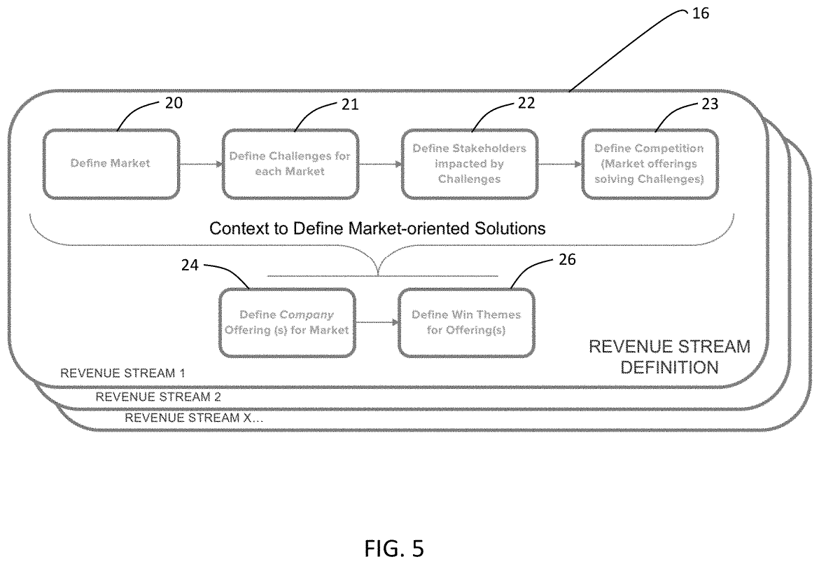

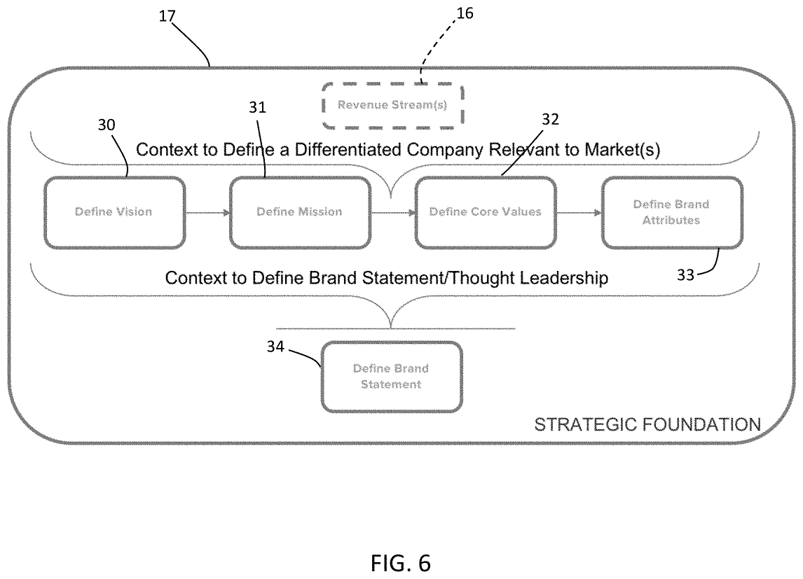

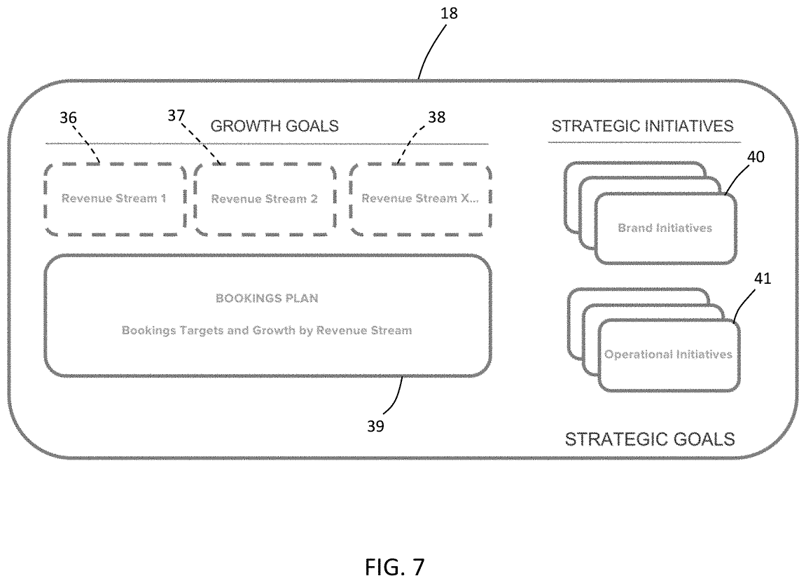

Referring to FIGS. 4-7, the step of strategy creation, block 11, is performed using a sequential approach to help companies build successful offerings based on market needs, block 16, consistently portraying their brand, block 17, and focusing on achieving clear annual goals, aligned throughout the entire organization, block 18.

The sequential approach creates clarity and enforces a methodical, strategic flow of decision making that includes the steps of:
1. Defining the Market: Identify the market or market segment you intend to serve, block 20.
2. Define Challenges for each Market: Identify the unmet needs in the market that you intend to solve, block 21.
3. Define Stakeholders: Identify the individuals (by role or characteristic) impacted by these challenges, block 22.
4. Define Competition: Identify available solutions that meet all or part of the challenge, block 23.
   Using this information:
5. Define the offerings your company provides to meet these market challenges, block 24. For each of these offerings, and with the context of the above, create the message “win themes” that will set your solution apart from the competition and appeal to your stakeholders, block 26.
   Repeat each step for each revenue stream.

Next, the company clearly defines why it exists, and what it stands for. This is foundational to the company's brand, and should guide the company over several years. With the context of the market and offerings (revenue streams) defined in the previous step, the platform 10 guides the development of key brand elements: company vision, block 30, mission, block 31, core values, block 32, and brand attributes, block 33. With those in mind, and considering its defined revenue streams, the platform 10 prompts leadership teams to create their brand statement or thought leadership position, block 34.

Last, strategic goals are defined. Given the intention to provide value to specific stakeholders by resolving defined market challenges, an organization needs to define their strategic goals that will move their company forward in the coming year(s).

The platform 10 aids in this process by dividing up the stated revenue streams and modeling out growth scenarios for each, blocks 36, 37, 38, and 39. Additionally, the platform 10 guides leadership teams through the process of stating indirect growth initiatives (branding and operational initiatives), blocks 40 and 41, to support their goals.

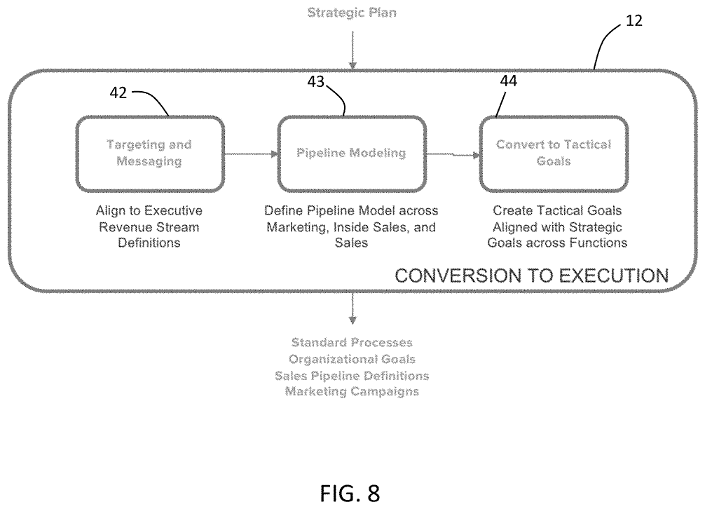

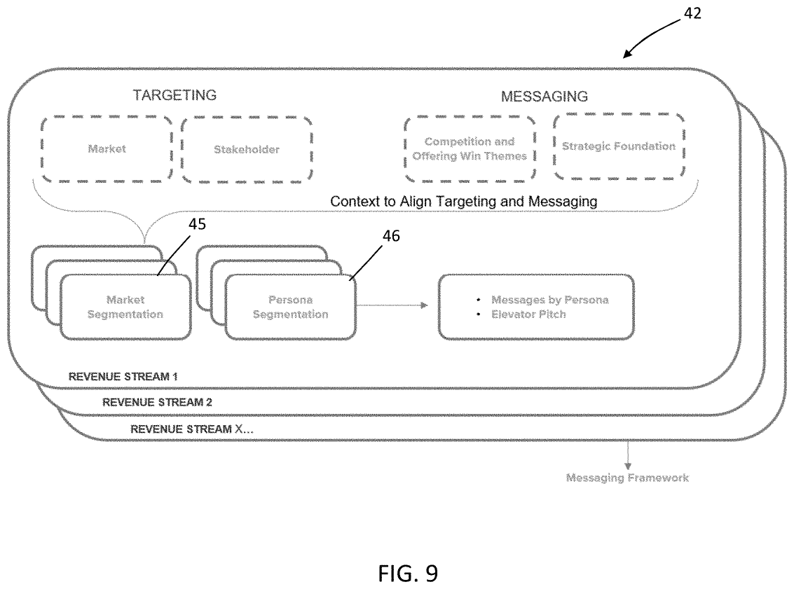

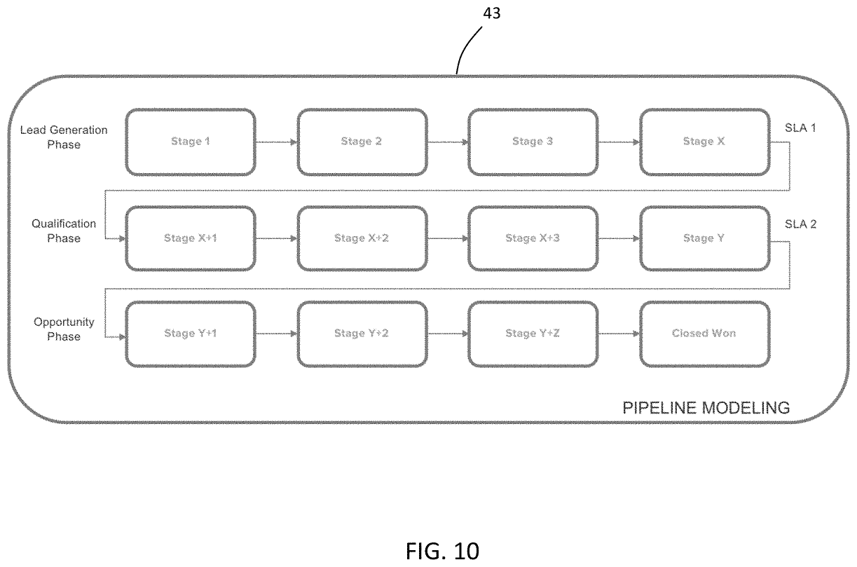

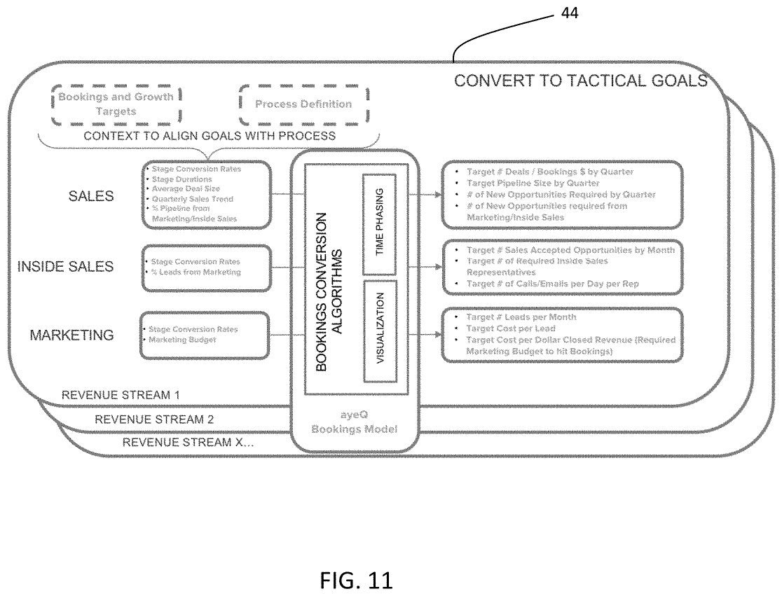

Referring to FIGS. 8-11, the step of conversion to execution, block 12, provides guidance through the conversion of the strategy developed above into executable directions, with goals, processes, and campaigns defined for the tactical systems using targeting/messaging, block 42, pipeline modeling 43, and tactical goals, block 44.

The first stage of conversion is to distill the higher-level markets and stakeholders, block 42, into market segments and personas, blocks 45 and 46. From there, the platform 10 guides the process of generating a messaging framework, blocks 46 and 47, using market segments, personas and the company branding.

Then the platform 10 defines standard marketing, inside sales, and sales processes. This process, plus the service level agreements (SLA) between functions, is the foundation for measuring performance. Complete visibility into a well-defined pipeline allows teams to see a won deal as a validation of their approach and a lost deal as a learning opportunity.

Lastly, the platform 10 distills strategic goals into tactical goals, block 44. The platform 10 aids in this effort with a series of scenario visualizations and algorithms, modeled over a period of time. The platform's Bookings Model produces valid metrics for each function that, if achieved, will result in the achievement of the company growth goals. This creates complete alignment across the growth functions, and allows the company to track actual performance and predict their revenue results.

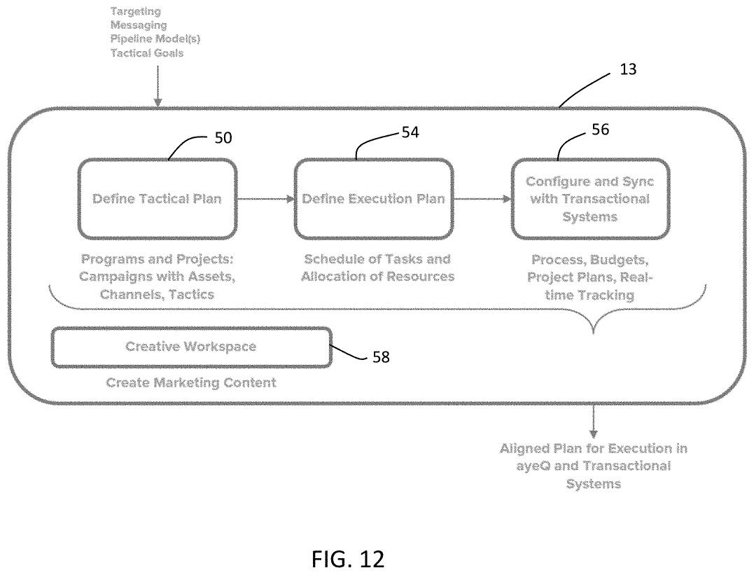

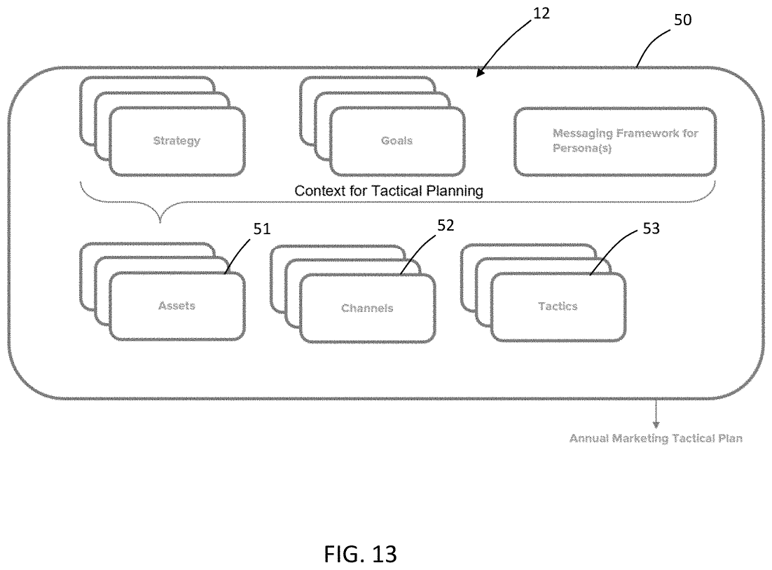

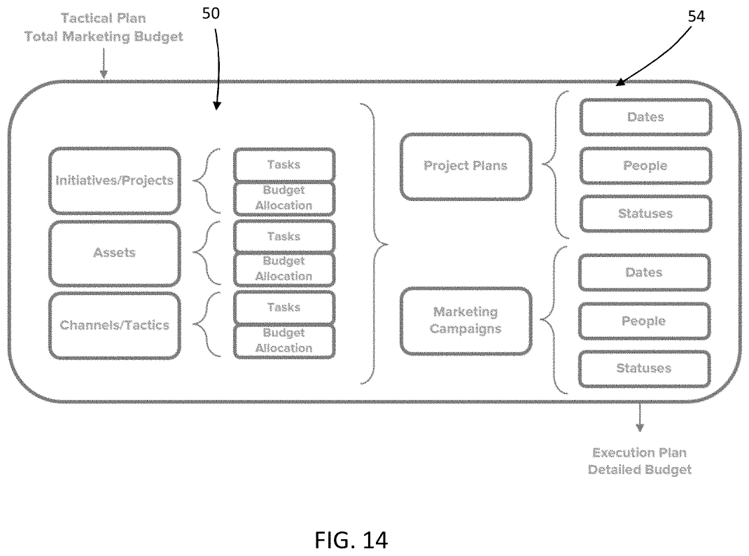

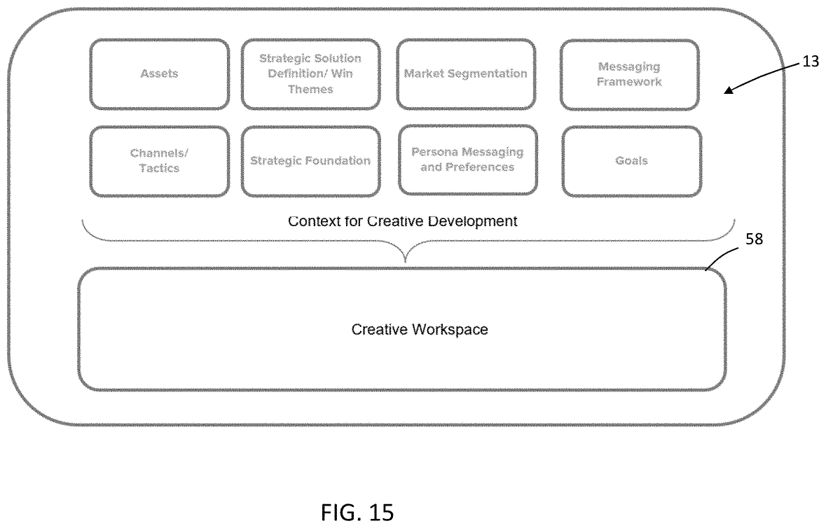

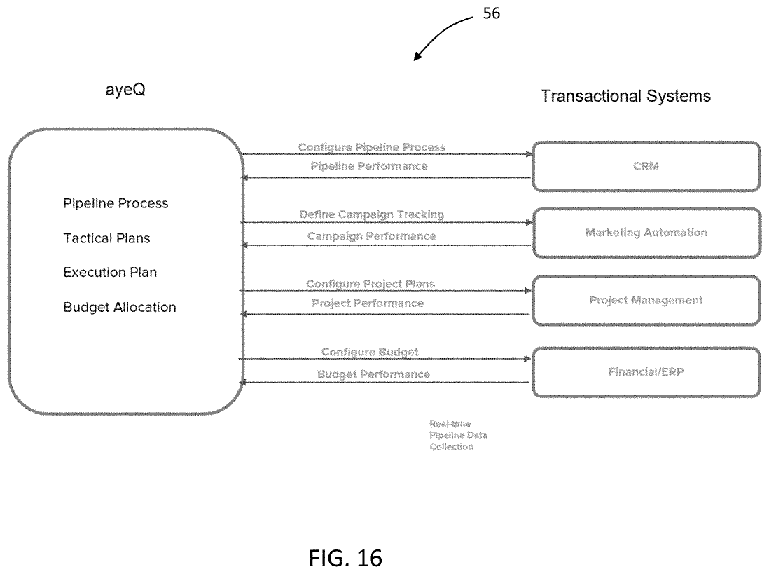

Referring to FIGS. 12-16, the strategy to execution step, block 13 (FIG. 2), ensures the day-to-day work completed (execution) is tied to strategy. Marketing teams typically operate with vague notions of “increase lead quantity” or “improve lead quality” without clear direction or rationale. When there is a strategy shift, the time it takes for that shift to be reflected in the organization's campaign/project planning and tactical execution is extremely slow at best, and non-existent in many cases. The strategy execution area in the platform 10 not only ensures that changes in strategy prompt changes in execution immediately, it also ensures that execution is developed based on the pre-defined strategy in the first place. The platform 10 enables marketing teams to flex their notorious powers of creativity towards a focused, measurable, and validated goal.

By focusing marketing teams working inside of the platform 10 on pre-defined targeting, messaging, pipeline model(s), and goal information, they develop actionable execution plans that are completely aligned with company strategy. In this phase, the platform 10 also integrates with existing transactional systems and drives strategic budget allocation.

The first phase is to define a tactical plan, block 50. This phase begins with an outline of upstream decisions made to guide the marketing team. Brand goals, strategic initiatives, revenue streams, key performance indicators/goals, and messaging guidelines by persona are logically depicted to the marketing team in order to give them clarity on what actions they need to take in order to aid the organization in achieving its growth goals.

With this information in mind, the marketing team is now ready for the first step in defining programs for lead generation and pipeline development, and projects to execute on strategic initiatives.

Once familiar with the contextual outline, the marketing manager selects what types of content, block 51, (webinars, eBooks, case studies, blogs, etc.) they want to create over the year, and how frequently they want to create them. Selection of the types of content is guided by communication preferences from the persona work completed upstream in the platform's strategy conversion section. Then, the marketing manager decides how to deliver this content to the intended audience by defining channels, block 52, and tactics, block 53, that make up campaigns. Guidance here also comes from the persona definitions provided.

Once Assets, Channels, and Tactics are selected, the marketing manager can now view an annual calendar to identify times throughout the year that staffing may need to increase (either staff the internal team or engage external agencies and partners), and shift dates based on any other factors—conferences, travel, holidays, etc. The calendar view of content is color-coded by persona—a visual to ensure the appropriate amount of content is being created with each persona, based on the value of the persona to the business.

At this point, overview of the Annual Marketing Tactical Plan and a total budget number from the finance team are shown. With a strategy-backed plan in place, the marketing team can begin to plan out how these campaigns will be executed, block 54—asset topics/titles, launch dates, specific audiences, internal campaign/project owners, deadlines, and budget allocation.

Not all marketing programs directly generate leads and pipeline growth. In some instances, executives may request marketing help on strategic initiatives and brand goals that indirectly impact growth. In these cases, it's important that the marketing team has a clear understanding of what the support request is, and how the executive team is measuring success. Since this information is supplied to the execution team in this planning phase, the marketing team can create project plans—specifying owners, start dates, deliverables, approvals, and budget allocation.

At this point, platform 10 has generated a very detailed execution plan to guide activities throughout the year, as well as a detailed budget showing how these plans will be supported financially.

Now that the marketing and creative teams have a detailed plan of what needs to be done, it's time to start working. In the Creative Workspace, block 58, creative teams review and synthesize the relevant context provided by the platform 10, brainstorm, and create the items needed in the execution plan. From webinars, to advertisements, to email blasts, to signage for events, and everything in between, platform 10 anchors the creative process in strategy—creating close alignment where today, there is none.

The platform 10 is designed to integrate with leading customer relationship management (CRM), marketing automation, project management, and financial/enterprise resource planning (ERP) systems. These integrations provide critical, real-time insight into pipeline, campaign, project, and budget performance, block 56.

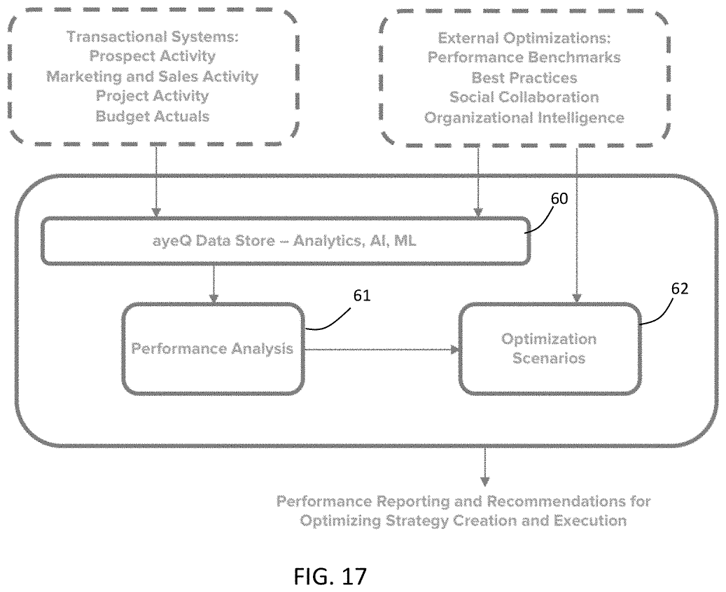

Referring to FIG. 17, the platform 10 defines a strategy as a structured set of attributes which can be optimized using analytics. The optimization phase, block 14, analyzes the performance of strategy based on its impact on revenue growth. Every attribute defined within the strategy creation, block 11, conversion, block 12, and execution phases, block 13, is linked to the generation of sales opportunities, as tracked within the company's tactical systems. These systems have been configured within the platform's conversion phase to align with the defined processes, and to feed details of each marketing and sales transaction back into the platform's data warehouse, block 60.

As marketing and sales activity takes place, platform 10 analyzes performance, block 61, relative to various strategy attributes, and provides an automated feedback loop into the strategy creation, block 11, conversion, block 12, and execution phases, block 13, for iterative improvements, block 62. Platform 10 illustrates strengths and weaknesses in the models, pipelines, personas and creative materials allowing for improvement in the respective areas as needed, facilitating a strong and focused growth cycle.

In addition, platform 10 integrates external optimization criteria to create a rich set of scenarios and recommendations for strategy improvement. These criteria include benchmarks created from the totality of the platform 10 community performance, best practices, social collaboration, and intelligence from across the organization. These inputs add to the performance analysis to create a collaborative component to the analytical feedback, all feeding into the strategy canvas for consideration as executives refine existing and create new strategies.

Boards are extremely interested in seeing a company's performance against an agreed-to-strategy. By using platform 10, that performance is automatically generated and displayed in the form of a board report that's available at any time.

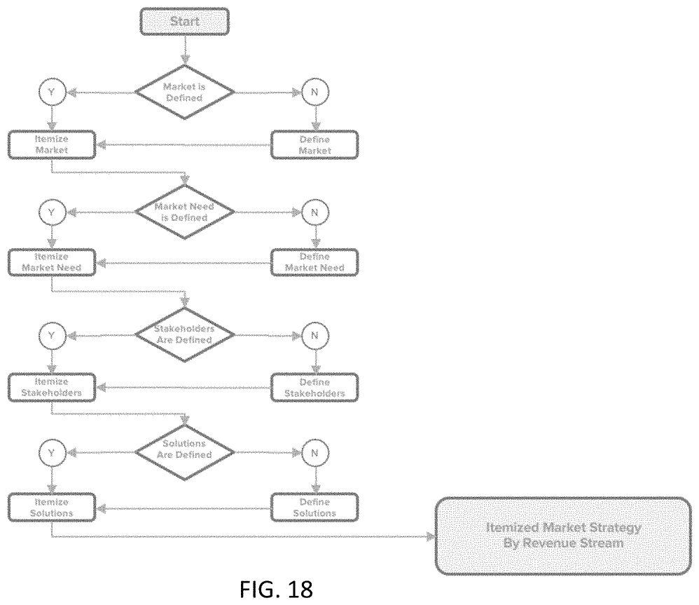

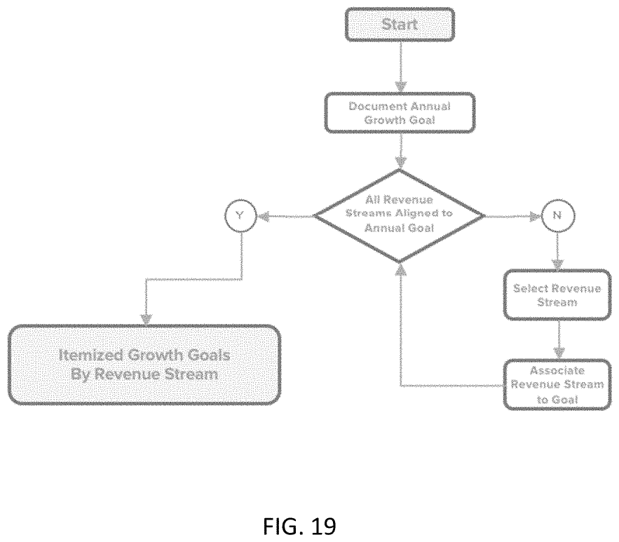

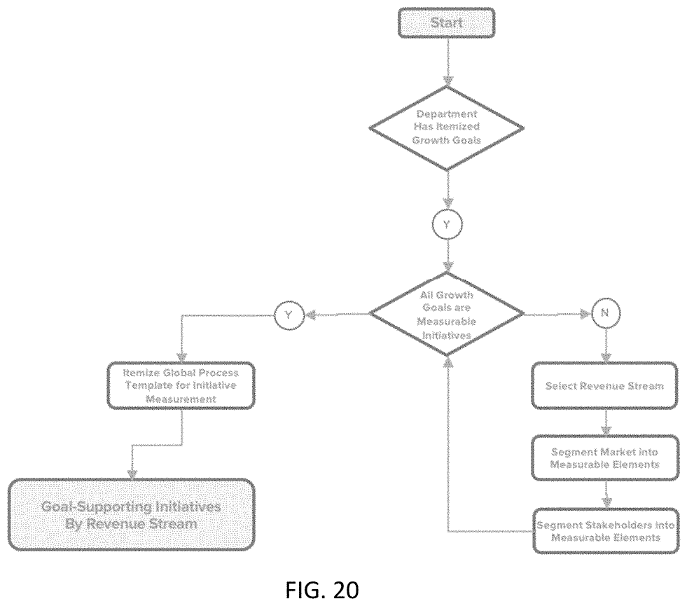

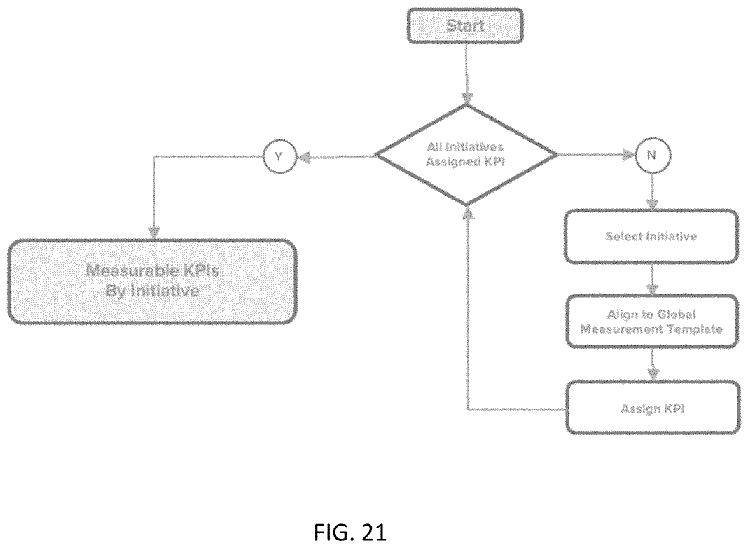

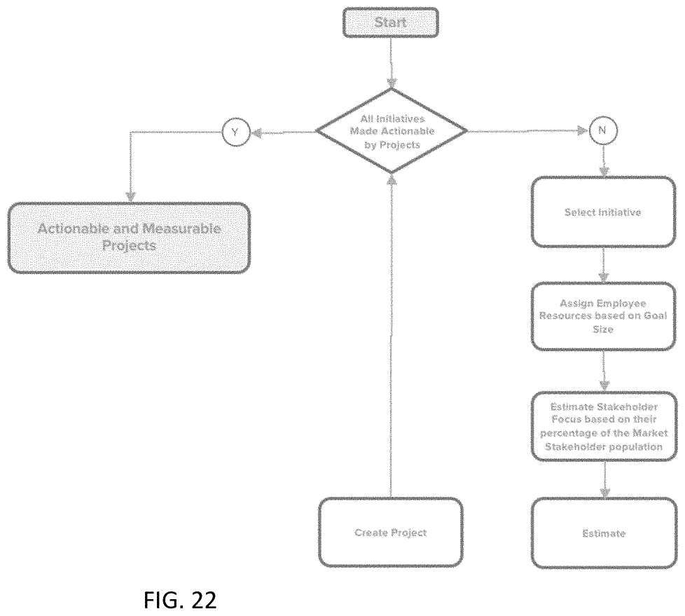

The platform 10 creates a structured representation of strategy. Once the strategy is defined in a structured manner, its performance can be analyzed using data science methods. The platform 10 analyzes strategy performance against bookings growth to optimize a company's approach to accelerating sales closure. The platform 10 uses the methods shown in FIGS. 18-22 to create the structured representation of strategy.

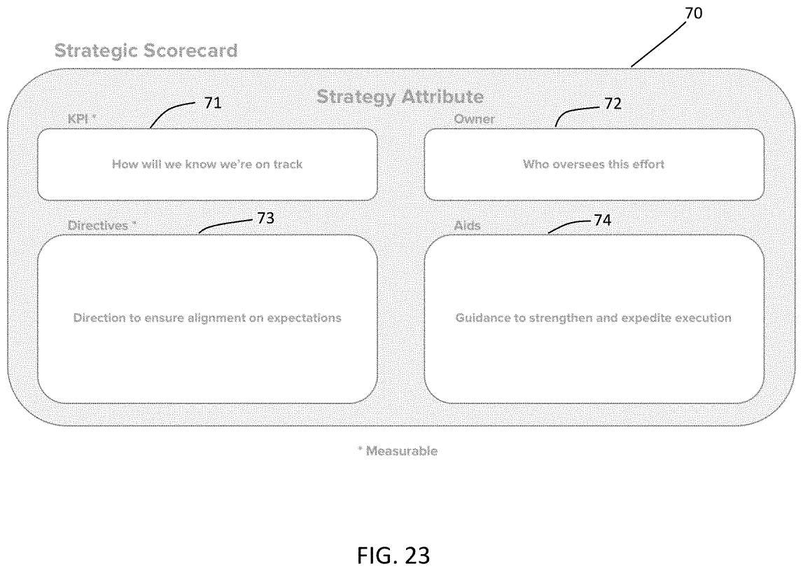

Referring to FIGS. 23-25, the platform 10 uses its structured (itemized) representation of strategy to provide a scorecard, block 70, to score its performance based on an assigned Key Performance Indicator (KPI), block 71. The platform 10 defines an owner, block 72, and enables the execution of each strategy attribute through directives, block 73, and aids, block 74.

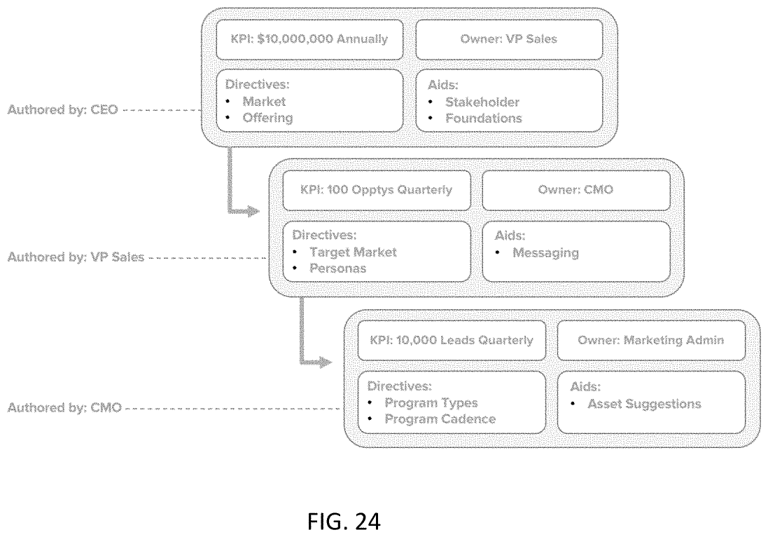

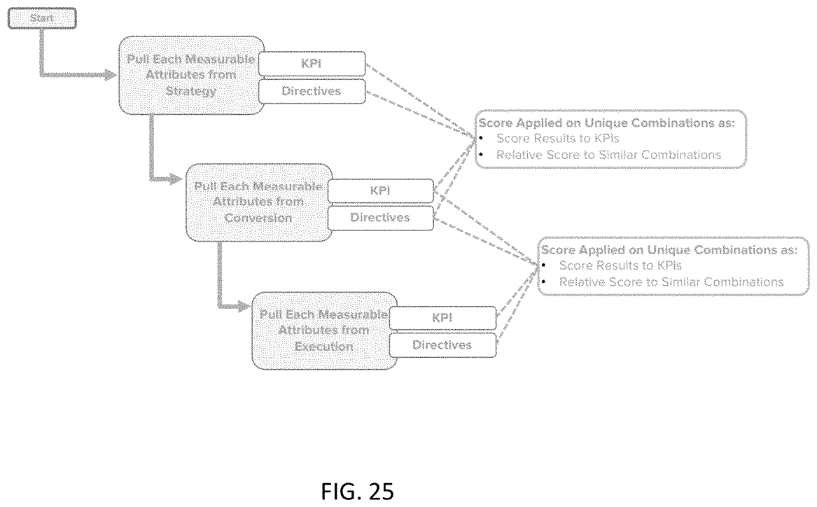

Platform 10 defines these elements to create a guided context for each part of the organization, directly aligning executive strategy setting with execution at every level. An example is provided in FIG. 24. As shown in FIG. 25, scores are used to measure relative performance across strategy attribute alternatives.

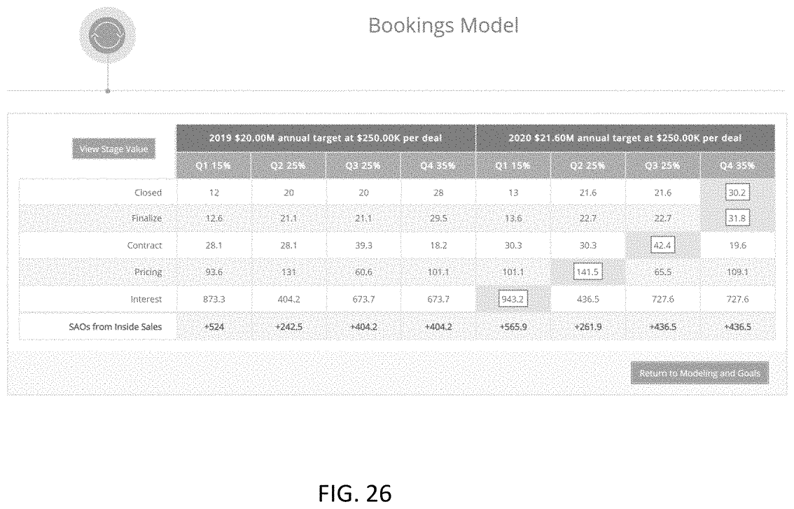

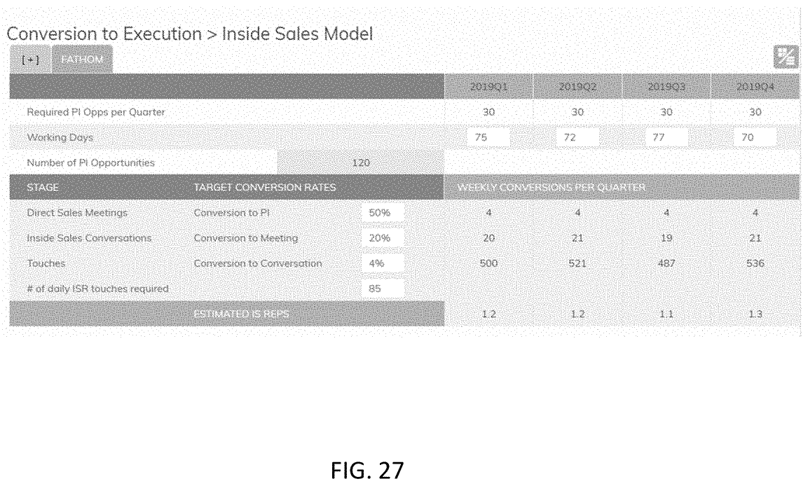

Referring to FIGS. 26 and 27, platform 10 defines a Bookings Model using algorithms, time phasing, and visualization. The Bookings Model creates organizational goals and KPIs based on the strategy-defined growth targets, the defined sales and marketing process, and the actual characteristics of the sales pipeline as tracked in the transactional system (CRM). The platform's Bookings Model creates a unique time-phased visualization to reveal how opportunities progress through the sales pipeline, and how goals should be propogated throughout the sales and marketing functions. The Bookings Model is interactive, and allows for the executive to run “what if” scenarios, and understand how the required goals translate to staffing plans.

The time phasing concept gives leadership a real-time look into how long the sales cycle will take to bear fruit. Instead of simply seeing this as a period of time between planning and profits, the model outlines a ramp-up in costs and resource needs to support the revenue goals. This allows for a more informed approach to goal-setting.

The foregoing has described an automated marketing strategy platform. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

We claim:

1. A marketing strategy automation system, comprising:
a processor;
a non-transitory computer readable storage medium coupled to the processor having stored thereon a plurality of instructions that, when executed by the processor, causes the processor to carry out a method, the instructions including:
a strategy module;
a conversion module;
an execution module; and
an optimization module.

2. The system of claim 1, wherein the strategy module includes the processes of:
defining a market or market segment a user intends to serve;
defining unmet needs in the market segment that the user intends to solve;
defining individuals impacted by the unmet needs; and
identifying available solutions that meet all or part of the unmet needs.

3. The system of claim 2, further including defining offerings the user provides to meet the unmet needs.

4. The system of claim 1, wherein the strategy module is programmed to model a growth scenario for a plurality of stated revenue streams.

5. The system of claim 1, wherein the conversion module includes the processes of:
distilling higher level markets and stakeholders into market segments and personas; and
generating a messaging framework using the market segments and personas.

6. The system of claim 5, further including defining standard marketing, inside sales, and sales processes into strategic goals.

7. The system of claim 6, further including distilling the strategic goals into tactical goals.

8. The system of claim 1, wherein the execution module includes the processes of:
defining a tactical plan with an outline of upstream decisions made to guide a marketing team;
defining an execution plan and displaying an overview of activities throughout a time period; and
enabling a creative workspace for individuals to synthesize and review relevant information.

9. The system of claim 1, wherein the optimization module includes the processes of:
converting unstructured strategy concepts into a structured representation of strategy.

10. The system of claim 9, further including creating an itemized strategy by revenue stream.

11. The system of claim 9, further including creating itemized growth goals by revenue stream.

12. The system of claim 9, further including creating goals supporting initiatives by revenue stream.

13. The system of claim 12, further including creating measurable key performance indicators by the goals supporting initiatives.

14. The system of claim 9, further including creating actionable and measurable projects.

15. A marketing strategy automation system, comprising:
a processor;
a non-transitory computer readable storage medium coupled to the processor having stored thereon a plurality of instructions that, when executed by the processor, causes the processor to carry out a method, the instructions including:
a strategy module, the strategy module including the processes of defining a market segment, defining unmet needs in the market segment; defining individuals impacted by the unmet needs, and identifying available solutions;
a conversion module, the conversion module including the processes of distilling higher-level markets and stakeholders into market segments and personas, and generating a messaging framework;
an execution module, the execution module including the processes of defining a tactical plan, defining an execution plan, and enabling a creative workspace for individuals to synthesize and review relevant information; and
an optimization module, the optimization module including the processes of converting unstructured strategy concepts into a structured representation of strategy.

16. The system of claim 15, wherein the strategy module is programmed to model a growth strategy for a plurality of stated revenue streams.

17. The system of claim 15, wherein the conversion module further includes the process of distilling strategic goals into tactical goals.

18. The system of claim 15, wherein the optimization module further includes the processes of creating an itemized strategy by revenue stream and creating itemized growth goals by revenue stream.

19. The system of claim 15, wherein the optimization module further includes the processes of creating goals supporting initiatives by revenue stream and creating measurable key performance indicators by the goals supporting initiatives.

20. The system of claim 15, wherein the optimization module further includes the process of creating actionable and measurable projects.
